(19) United States
(12) Patent Application Publication
(10) Pub. No.: US 2007/0258611 A1
(43) Pub. Date: Nov. 8, 2007

(54) Angle-adjustable mechanism for portable speaker system

(75) Inventor: Zu-Nan Li, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., Taipei (TW)

(21) Appl. No.: 11/451,360

(22) Filed: Jun. 13, 2006

(30) Foreign Application Priority Data
May 3, 2006 (TW) 095115708

(51) Int. Cl. H04R 1/02

(52) U.S. Cl. 381/335; 381/334; 381/336

(57) ABSTRACT

An angle-adjustable mechanism for a speaker system includes a housing and a plurality of speakers. The housing has an opening for accommodating and pivoting a console within the opening. The housing and the speakers can therefore be rotated to a desired angle relatively to the console. The speaker system may be alternatively coupled, by way of example, to either a computer system or an MP3 player.

### BACKGROUND OF THE INVENTION

1. Field of the Invention

The present invention relates to a portable speaker system, and in particular to a mechanism enabling speakers to be adjusted relative to a console.

2. Description of the Prior Art

Because of the great popularity of MP3 devices and the like, a variety of portable computer speakers capable of being coupled not only to a computer, but also to an MP3 device, have become available.

Logitech® mm22 Portable Speakers, for example, have base, and a pair of foldable speakers at each end of the base. An MP3 device, such as Apple Corporation's iPod®, can be inserted into a socket on the base. The user may spread out each of the speakers such that the base and the pair of speakers will assume a U-shape configuration. However, the speakers cannot be adjusted to a preferred angle position, and therefore sound waves generated by the speakers will not be properly projected to the surroundings for premium quality listening.

Another example is the Logitech® mm50 Portable Speakers system, which has a rigid configuration for installing a pair of speakers at each end of a base. Also, an MP3 device, such as an iPod®, can be inserted into a socket on the base. Again, because the angle of the speakers is fixed, sound waves generated by the speakers will not be properly projected to the surroundings to favor the listener.

### SUMMARY OF THE DISCLOSURE

It is an object of the present invention to provide an angle-adjustable mechanism for a portable speaker system, in which a plurality of speakers can be adjusted to a desired angle relatively to a console.

It is another object of the present invention to provide an angle-adjustable mechanism for a portable speaker, in which the console can be folded into an opening for easy transport.

To accomplish the advantages mentioned above, the speaker system comprises a housing, and a pair of speakers. Each of the speakers is located at each end of the housing, and the housing has an opening located between the pair of speakers for accommodating a console therebetween. The housing has a top frame and an inner side frame next to the opening, and the console is pivotally connected to the inner side frame. Therefore, the housing, the top frame, the inner side frame and the pair of speakers can be rotated to a desired angle relative to the console.

### BRIEF DESCRIPTION OF THE DRAWINGS

FIG. 1 is a perspective exploded view of a first preferred embodiment of the present invention.

FIG. 2 is a perspective view of the first preferred embodiment.

FIGS. 3a-3c illustrate the manner in which the housing of the invention is rotated to a desired angle.

FIG. 4 is a perspective view of the invention according to a second preferred embodiment.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

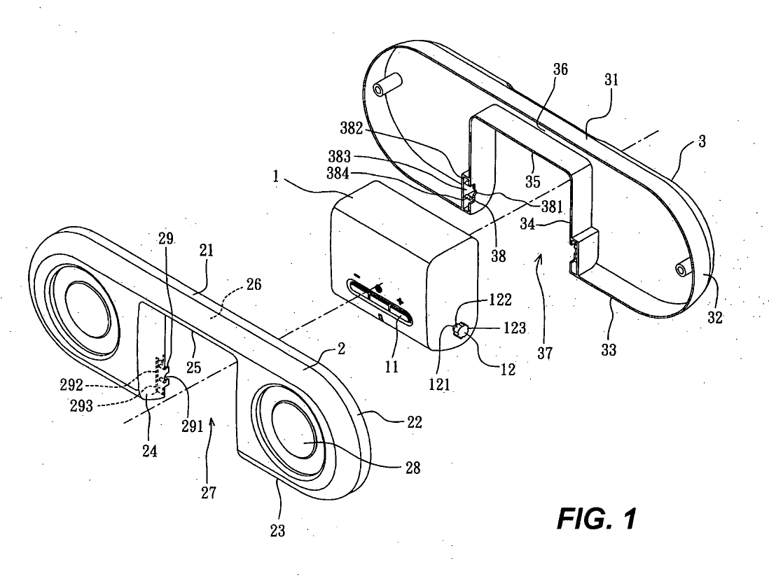

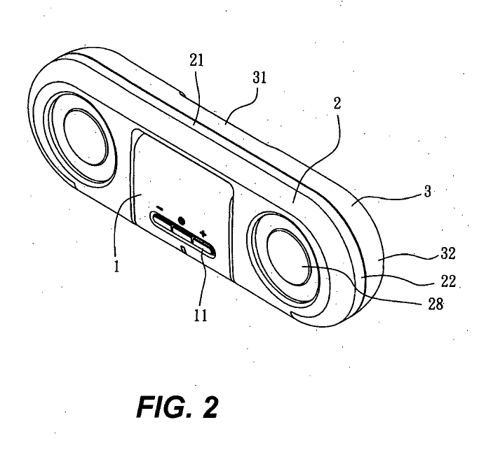

Please refer to FIGS. 1-2. The speaker system comprises a console 1, and a housing which further has an upper housing 2 and a lower housing 3. The console 1 is a controlling device which can control the volume of the speaker or the like via a plurality of buttons 11. A portable device, such as an MP3 device, or a computer system, may couple to the console by a cable or wireless interface, examples of suitable cable or wireless interfaces being well-known in the field. In addition, each end of the console 1 has an axle 12, and each of the axles 12 has a neck 121, and several detent-like lobes 122 which are evenly separated by several grooves 123. Each end of the housing has a speaker 28 so as to constitute a stereo speaker system.

The upper housing 2 has a top frame 21, a pair of side frames 22, and a pair of bottom frames 23 which are respectively located under the speakers 28. The upper housing 2 further has a pair of inner side frames 24, an inner top frame 25, a gap 26 and an opening 27. Correspondingly, the lower housing 3 has a top frame 31, a side frame 32, and a pair of bottom frames 33 which are respectively located under the speakers 28. The upper housing 3 further has an inner side frame 34, an inner top frame 35, a gap 36 and an opening 37.

Each of the inner side frames 24 further has a protrusion 29 which has a recess 291, a compartment 292, and a chamber 293. Correspondingly, each of the inner side frames 34 further has an opening 38 which has a recess 381, a compartment 382, and a chamber 383. In addition, there is a flexible clip 384 located within the chamber 383. The clip 384 can have a C-shape like configuration.

Once the upper housing 2, console 1, and lower housing 3 are assembled together, the console 1 will be positioned within the openings 27 and 37. Also the gaps 26, 36 will be positioned between the top frames 21, 31 and the console 1. Each of the axles 12 will be contained within the compartments 292 and 382, and be positioned between the chambers 293 and 383 such that each of the necks 121 will be positioned between the recesses 291 and 381. Finally, two of the grooves 123 will be captured by the clip 384. Therefore the console 1 can be rotated within the housing, and the clip 384 can position either the console 1 or the housing at a desired angle.

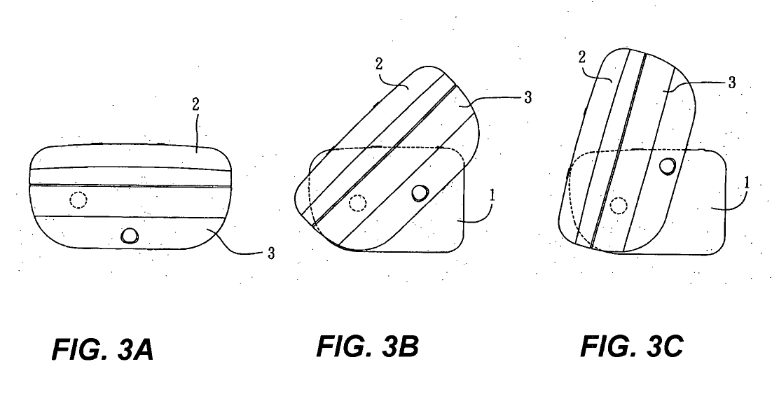

Please refer to FIGS. 3A-3C. When a user places the housing on a table, the user may leave the console 1 on the table and lift the housing up from the gaps 26,36 by holding the top frames 21,31. In other words, the housing will be rotated relatively to the console 1. Due to the groove 123 of the axles 12 bring captured by the clips 384, the housing can be rotated and positioned at several angles. Once the console 1 is rotated, an upper lobe 122 and a lower lobe 122 of the axle will push and enlarge (deform) the flexible clip 384 in the chambers 293 and 383, such that the axles 12 can be further rotated step by step. It is understood that when the upper and lower lobes 122 move across the clip 384, the clip 384 will hold the axles 12 at upper and lower grooves 123, which is why the housing can be rotated step by step.

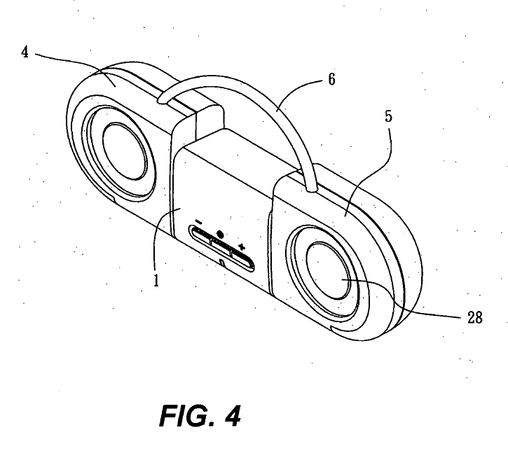

FIG. 4 shows a second embodiment of the invention. The top frames 21 and 31 can be linked by a single handle 6. The handle 6 couples to each side of the housing. By the structure mentioned above, the user may carry the speaker system for transport by folding the console 1 to be in line with the housing. As in the first embodiment, the console 1 can be rotated within the opening of the housing, and the clip 384 can position either the console 1 or the housing at a desired angle.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An adjustable mechanism for a portable speaker system, comprising:
a housing and a pair of speakers;
wherein the housing has an opening located between the speakers for accommodating a console therebetween;
wherein the housing has a top frame and an inner side frame next to the opening, the console is pivotally connected to the inner side frame; and a gap is located between the top frame and the console;
whereby the housing, the top frame, the inner side frame and the pair of speakers are rotatable to a desired angle relative to the console.

2. The speaker system as claim in claim 1, wherein the housing at least has a compartment, and the console at least has a detent-like device; the detent-like device being accommodated within the compartment for positioning the pair of speakers at said desired angle relative to the console.

3. The speaker system as claim in claim 2, wherein the compartment further has a flexible clip for preventing the detent-like device from rotating in order to hold the speakers at said desired angle.

4. The speaker system as claim in claim 1, wherein the console is arranged to be wiredly or wirelessly coupled to a portable device or a computer system.

5. An adjustable mechanism for a portable speaker system, comprising:
a housing and a pair of speakers;
wherein the housing has an opening located between the pair of speaker for accommodating a console therebetween;
wherein the housing has a handle formed across a top of the opening and an inner side frame next to the opening, and wherein the console is pivotally connected to the inner side frame; a gap being located between the top frame and the console; and
whereby the housing, the handle, the inner side frame and the pair of speakers are arranged to be rotated to said desired angle relative to the console.

6. The speaker system as claim in claim 5, wherein the housing at least has a compartment, and the console at least has a detent-like device; the detent-like device being accommodated within the compartment for positioning the speaker to said desired angle relative to the console.

7. The speaker system as claim in claim 6, wherein the compartment further has a flexible clip for keeping the detent-like device from rotating in order to hold said speakers at said desired angle.

8. The speaker system as claim in claim 5, wherein the console is arranged to be wiredly or wirelessly coupled to a portable device or a computer system.

9. A foldable speakers system, comprising:
a housing and a plurality of speakers;
wherein the housing has an opening for accommodating and pivoting a console within the opening;
wherein a gap is located between the housing and the console;
whereby the housing and the speakers are arranged to be rotated to a desired angle relatively to the console.

10. The speaker system as claim in claim 9, wherein the housing at least has a compartment, and the console at least has a detent-like device; the detent-like device being accommodated within the compartment for positioning the speakers to said desired angle relative to the console.

11. The speaker system as claim in claim 9, wherein the compartment further has a flexible clip for keeping the detent-like device from rotating in order to hold said speakers at said desired angle.

12. The speaker system as claim in claim 11, wherein the console is wiredly or wirelessly coupled to a portable device or a computer system.
